(19) United States
(12) Patent Application Publication
(10) Pub. No.: US 2010/0066897 A1
(43) Pub. Date: Mar. 18, 2010

(54) IMAGE PICKUP APPARATUS AND CONTROL METHOD THEREOF

(75) Inventor: Hiroshi Miyanari, Yokohama-shi (JP)

Correspondence Address: COWAN LIEBOWITZ & LATMAN P.C.;JOHN J TORRENTE, 1133 AVE OF THE AMERICAS, NEW YORK, NY, 10036, US

(73) Assignee: CANON KABUSHIKI KAISHA, Tokyo (JP)

(21) Appl. No.: 12/557,185

(22) Filed: Sep. 10, 2009

(30) Foreign Application Priority Data
Sep. 16, 2008 (JP) 2008-237185

(51) Int. Cl. H04N 5/235

(52) U.S. Cl. 348/362; 348/E05.034

(57) ABSTRACT

When luminance of an object changes, aperture value and shutter speed are changed. Shutter speed, in case of an electric shutter, is changed immediately. On the other hand, aperture value is driven over the span of several frames, due to delays in communication between the lens and the camera body or mechanical delays. During aperture driving duration, the aperture value deviates from the program diagram, leading to inappropriate exposure and drop in image quality. Correction coefficient B is calculated from ratio of luminance values of certain regions of a frame that are appropriately exposed according to the program diagram and a frame that are inappropriately exposed and deviates from the program diagram. Then, correction of gain is performed on the frames that are inappropriately exposed using the correction coefficient B, obtaining output image signals for which deterioration in image quality due to inappropriate exposure is suppressed.

### BACKGROUND OF THE INVENTION

1. Field of the Invention

The present invention is related to an image pickup apparatus which is capable of picking up moving images, and a control method thereof. In particular, the present invention is related to an image pickup apparatus that automatically controls exposure by driving the aperture based on picked up images, and a control method thereof.

2. Description of the Related Art

In recent years, digital single lens reflex (DSLR) cameras with interchangeable lens system have become capable of picking up moving images, and also come with live-view function. Interchangeable lenses of DSLR cameras can be divided into two types: the first type performing aperture driving with an aperture varying means placed within the interchangeable lens; and the second type performing aperture driving from the camera body through a mechanical transmission mechanism. The interchangeable lenses of the first type can drive the aperture in finely divided steps, allowing smoother adjustment to the exposure conditions. In comparison, it is difficult to smoothly drive the interchangeable lenses of the second type.

In order to resolve problems which are inherent in the second-type interchangeable lenses, Japanese Patent Laid-Open No. 2002-290828 suggests a technique of restricting the number of steps in aperture value and performing control of shutter speed at each one of aperture values, thereby suppressing aperture driving. According to Japanese Patent Laid-Open No. 2002-290828, it is possible for the second-type interchangeable lenses to attain a level of smoothness that is close to the first-type interchangeable lenses when changing the exposure conditions in response to change in luminance of the object.

On the other hand, in recent years, there are many DSLR cameras with the above-mentioned interchangeable lens systems employing CMOS image sensors as the image pickup device, in place of the traditional CCD sensors. CMOS stands for Complementary Metal-Oxide Semiconductor. These CMOS image sensors are advantageous in that they consume less power, they operate at a lower voltage, their speed of reading electric charges can be increased, when compared to CCD image sensors.

Meanwhile, automatic exposure control in cameras, as is already well known, is performed by following program diagram which indicates the relationship between aperture value of lens, shutter speed, and EV value. Appropriate exposure is performed by controlling the aperture driving and shutter speed which are suitable for an EV value of an object according to the program diagram.

On the other hand, because delays in communication between the camera body and the lens, and mechanical delays due to aperture driving itself occur, the period of aperture driving may span over multiple frames in a moving image. Control of shutter speed can be performed electronically by controlling the time for electric charge accumulation at the image pickup device on the side of the camera body. In this case, control of aperture driving lags behind the control of shutter speed, causing deviations of shutter speed and aperture value from the line of the program diagram. Due to this, appropriate exposure control cannot be attained, leading to quality deterioration in picked-up moving images.

When using a method such as that described in Japanese Patent Laid-Open No. 2002-290828 above, situations occur in which shutter speed and aperture value deviate from the line of the program diagram and exposure control is not appropriately performed. This is particularly prominent when a CMOS image sensor is used as the image pickup device and the shutter control is performed using an electronic rolling shutter.

This problem is explained using FIGS. 11A to 1E. FIGS. 11A to 11E show an example of aperture value and shutter speed control in accordance with a program diagram, in response to change in luminance (EV value) of an object when picking up a moving image.

In FIGS. 11A to 11E, time progresses from left to right. Numbers #1-#6 show corresponding frames. FIG. 11A shows change in luminance of the object for each frame. FIG. 11B shows an example of driving an image pickup device by an electronic rolling shutter, wherein the vertical direction indicates the order of lines of the image pickup device. Areas that are not shaded indicate time for electric charge accumulation in the order of lines. The time for accumulation for a single line corresponds to shutter speed. FIG. 11C indicates aperture, wherein the upper side is an open state with a small aperture value. In other words, FIG. 11C shows a situation where the aperture is driven one step towards closure. FIG. 11D roughly indicates images and exposure conditions of each of the frames obtained by exposure of the image pickup device. FIG. 11E shows examples of image data, which are eventually displayed or recorded in response to exposure of the image pickup device, for each frame.

Because the image pickup device is driven by an electronic rolling shutter, delay in frame occurs in comparison to change in luminance of an object. In the example provided in FIGS. 11A to 11E, a delay of 2 frames occurs from the onset of scanning at the image pickup device to obtaining an image, as shown in FIGS. 11A to 11D.

As shown in FIG. 11A, the case will be analyzed where shutter speed and aperture value are controlled in response to a drastic change in luminance of the object such as that shown in frame #2. Based on the image signal read out from frame #2 which experienced a change in luminance, shutter speed and aperture value are calculated in accordance with the program diagram. Based on the calculated shutter speed and aperture value, control of shatter speed and aperture driving is performed.

In the case of an electronic rolling shutter, the shutter speed is immediately implemented. As illustrated in FIG. 11B, since scanning for frame #3 has already being initiated at time point A, shutter speed is modified to the value according to the program diagram from the subsequent frame #4.

To the contrary, driving of the aperture, as mentioned above, is delayed for communicative and mechanical reasons. Therefore, it takes time, for example several frames, from initiating control to reaching the desired aperture value. In the example given in FIG. 11C, an amount of time equivalent to 1.5 frames is consumed from the onset of control to time point A, in which case the frame at which the desired aperture value according to the program diagram is attained is frame #5.

For this reason, until frame #5 wherein the desired aperture value is attained, exposure control in accordance with the program diagram is not performed, resulting in overexposed images (or underexposed images). Due to this, problems such as deterioration of picked-up image quality and overexposure (or underexposure) of displayed or recorded images occur.

### SUMMARY OF THE INVENTION

Accordingly, a feature of the present invention is to provide an image pickup apparatus capable of suppressing changes in exposure in response to changes in luminance of the object when picking up a moving image, and a method of controlling the image pickup apparatus.

According to an aspect of the present invention, there is provided an image pickup apparatus comprising: an image pickup unit that generates an image signal by photoelectric conversion of light flux incoming via an aperture; a detection unit that detects luminance of an image signal generated by the image pickup unit; a computing unit that computes an aperture value of the aperture based on the detection result of the detection unit; an exposure control unit that performs exposure control by adjusting the aperture to the aperture value computed by the computing unit; and a correction unit that performs correction of luminance on an image signal generated by photoelectric conversion of the light flux incoming to the image pickup unit when performing adjustment of the aperture in response to change in luminance of an object, based on luminance of an image signal generated prior to performing the adjustment of the aperture.

According to another aspect of the present invention, there is provided a method of controlling an image pickup apparatus having an image pickup unit that generates an image signal by photoelectric conversion of light flux incoming via an aperture, the method comprising: a detection step of detecting luminance of an image signal generated by the image pickup unit; a computing step of computing an aperture value of the aperture based on the detection result from the detection step; an exposure control step of performing exposure control by adjusting the aperture to the aperture value computed at the computing step; and a correction step of performing correction of luminance on an image signal generated by photoelectric conversion of the light flux incoming to the image pickup unit when performing adjustment of the aperture in response to change in luminance of an object, based on luminance of an image signal generated prior to performing the adjustment of the aperture.

The present invention can suppress changes in exposure in response to changes in luminance of the object when picking up a moving image.

Further features of the present invention will become apparent from the following description of exemplary embodiments with reference to the attached drawings.

### BRIEF DESCRIPTION OF THE DRAWINGS

FIG. 1 is a block diagram illustrating an exemplary configuration of a DSLR camera to which a first embodiment of the present invention can be applied.

FIG. 2 shows an exemplary configuration of an image pickup device.

FIG. 3 shows an example of driving pulses and operation sequence in the operation of an electronic rolling shutter.

FIG. 4 illustrates an exemplary program diagram, which is applicable to the present invention, for picking up moving images for live view and storage.

FIGS. 5A to 5F show an exemplary operation, according to the first embodiment of the present invention, for cases in which the luminance of the object has changed while picking up a moving image pickup and the aperture value has advanced to a next step.

FIG. 6 explains a method of calculating correction coefficient B according to the first embodiment of the present invention.

FIG. 7 is a block diagram showing an exemplary configuration of a DSLR camera to which a second embodiment of the present invention can be applied.

FIGS. 8A to 8I show an exemplary operation, according to the second embodiment of the present invention, for cases in which luminance of the object has changed while picking up a moving image and the aperture value has advanced to a next step.

FIGS. 9A to 9F show an exemplary operation, according to a third embodiment of the present invention, for cases in which luminance of the object has changed while picking up a moving image and the aperture value has advanced to a next step.

FIG. 10 explains an exemplary method of calculating a vertical direction gain correction value G(v) according to the third embodiment of the present invention.

FIGS. 11A to 11E show an exemplary operation for cases in which the luminance of the object has changed while picking up a moving image and the aperture value has advanced to a next step, which illustrates problems associated with prior art.

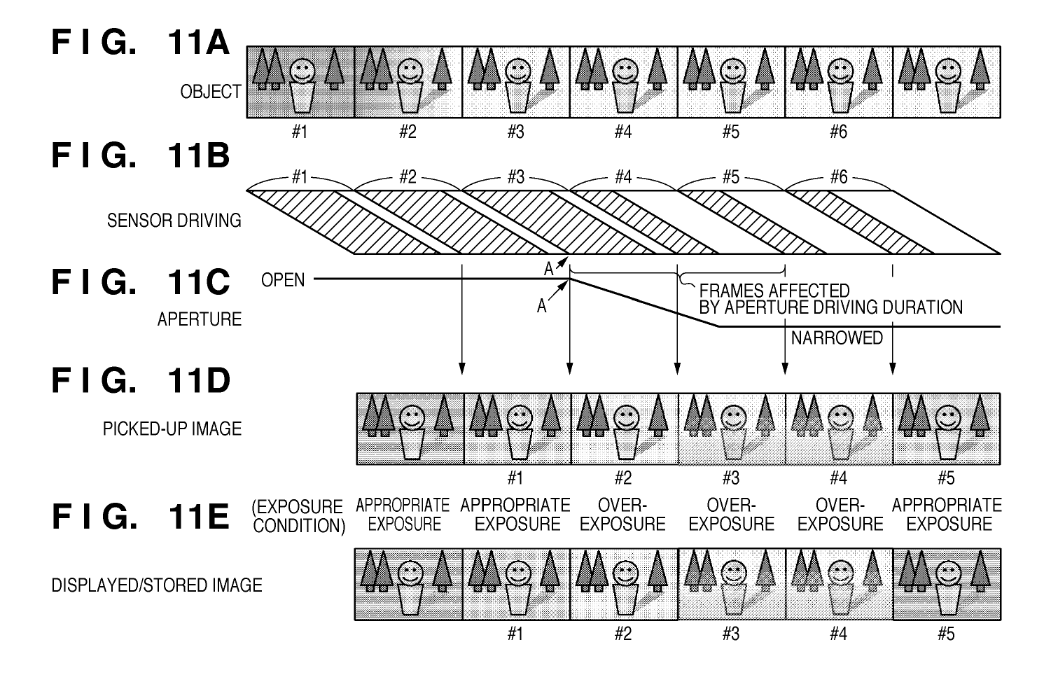

### DESCRIPTION OF THE EMBODIMENTS

### First Embodiment

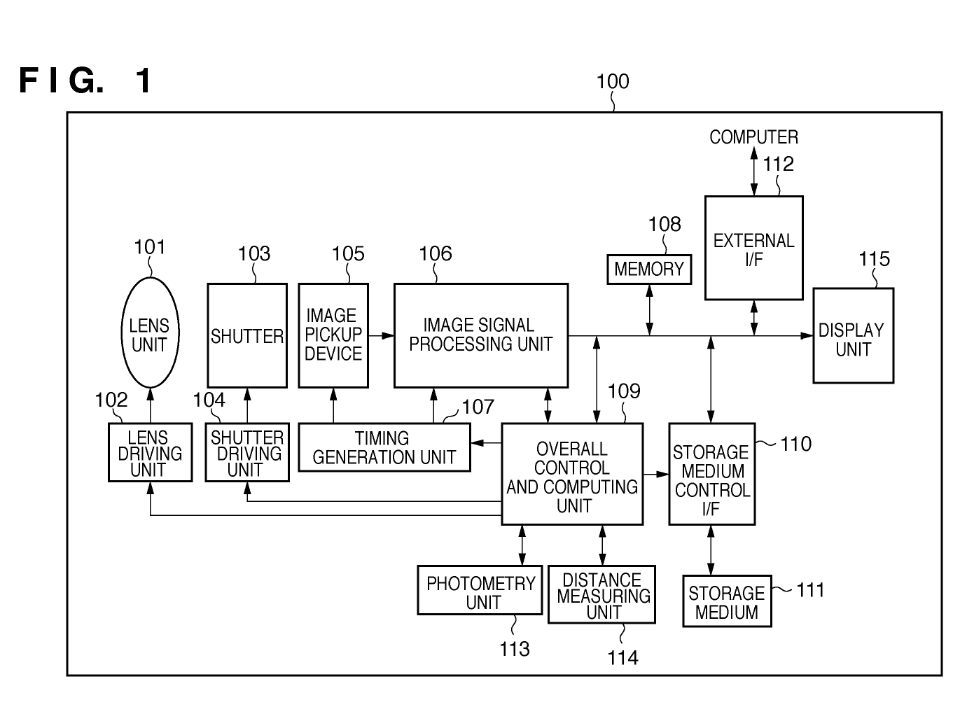

A first embodiment of the present invention will be explained below with reference to figures. FIG. 1 illustrates an exemplary configuration of a DSLR camera 100 to which the first embodiment of the present invention can be applied. An overall control and computing unit 109 has, for example a CPU, a ROM and a RAM, the CPU operating with the RAM being a work memory according to a program pre-stored in the ROM, thereby controlling the entire DSLR camera 100. The ROM further pre-stores a program diagram for controlling exposure. Additionally, the overall control and computing unit 109, when functioning as correction means, computes image pickup parameters and correction processing coefficient of image data according to the program.

A lens unit 101 is configured to be exchangeable in relation to the camera body and include an optical aperture mechanism, allowing incoming light to be irradiated onto an image pickup device 105 (to be explained later). A lens driving unit 102, which acts as driving means, performs adjustment of the aperture by driving the optical aperture mechanism (not shown) at the lens unit 101 according to the control by the overall control and computing unit 109 which acts as control means. The driving of the optical aperture mechanism by the lens driving unit 102 is performed in a step-wise fashion. Additionally, the lens driving unit 102 drives a zoom optical system (not shown) and an image forming optical system (not shown) of the lens unit 101 according to the control by the overall control and computing unit 109, thereby performing zoom control and focus control.

The lens driving unit 102 is incorporated into, for example, the camera body side, mechanically transmits driving force to each of the mechanisms of the lens unit 101, thereby performing control of these components. Without restricting to this particular arrangement, it is also possible to incorporate the lens driving unit 102 on the side of the lens unit 101, performing communication with the camera body side, thereby controlling these components.

A shutter unit 103 is, for example, a mechanical shutter, and is driven by a shutter driving unit 104 that is controlled by the overall control and computing unit 109 and shields the image pickup device 105 during image pickup. The shutter unit 103 is driven by the shutter driving unit 104 and is maintained in a non-shielded state, i.e. in a flipped-up position, when picking up moving images. The image pickup device 105, which acts as image pickup means, has sensors that utilize an XY address scanning method, accumulates electric charge in accordance with the light amount of light flux received from an object, and generates image signals of the object based on the accumulated charge. In the first embodiment of the present invention, a CMOS image sensor is used as the sensor of the image pickup device 105.

An image signal processing unit 106 executes noise canceling and amplifying processes on the image signals outputted from the image pickup device 105, and further executes A/D conversion to convert the signals to digital image data. Further, the image signal processing unit 106 executes various types of image processing such as gamma correction and white balance correction. In addition, the image signal processing unit 106 is capable of executing compression-encoding processing using a given method on image data on which image processing is executed.

The overall control and computing unit 109 performs luminance detection on image signals provided to the image signal processing unit 106 and detects luminance components, which then can perform photometry based on these detected luminance components. Further, the overall control and computing unit 109 can calculate sharpness of an image based on the luminance components, which enables acquisition of focus information.

A timing generation unit 107 generates timing signals for the image pickup device 105 and the image signal processing unit 106 in accordance with the control of the overall control and computing unit 109. The image pickup device 105 is driven based on the timing signals provided by this timing generation unit 107. Further, the image signal processing unit 106 can simultaneously perform processing of the image signals outputted by, for example, the image pickup device 105 based on the timing signals provided from the timing generation unit 107.

A memory 108 temporarily stores compressed or non-compressed output image data outputted from the image signal processing unit 106. A storage medium control interface (I/F) 110 controls storage and replay of data to and from a storage medium 111. For example, the storage medium control I/F 110 reads out image data from the memory 108, and stores it in the storage medium 111. The storage medium 111 is, for example, a and re-writable non-volatile memory which is removable from the DSLR camera 100.

A display unit 115 is made of, for example, a display device such as an LCD and a driving circuit therefor, and displays images according to the output image data from the image signal processing unit 106 on the display device. The display unit 115 also may display the stored image data read out from the memory 108 on the display device. For example, live view is performed by continuously outputting frame image signals from the image pickup device 105 at predetermined intervals, for example outputting signals at each frame cycle, sequentially processing the frame image signals at the image signal processing unit 106, and displaying them on the display unit 115.

An external I/F 112 is an interface for performing data communication with external devices. The DSLR camera 100 can perform data transmission with external computers and such via this external I/F 112.

A photometry unit 113 measures luminance of objects. Further, a distance measuring unit 114 measures the distance to objects. Measurement results from the photometry unit 113 and the distance measuring unit 114 are each supplied to the overall control and computing unit 109. When picking up still images, the overall control and computing unit 109 calculates an EV value based on the luminance measurement result outputted from the photometry unit 113. Likewise, the overall control and computing unit 109 detects focus state of the object based on the measurement result outputted from the distance measuring unit 114.

Next, the configuration of the image pickup device 105, which is an XY address scanning device, and its scanning method, will be explained. Regarding scanning of the image pickup device 105, first, a scan (reset operation hereinafter) to remove unnecessary accumulated electric charge is performed per pixels or lines. After the reset operation, electric charge is accumulated for each of the pixels by photoelectric conversion according to the light received at the image pickup device 105. Then, by performing a scan to read out the signal electric charge per pixels or lines, the charge accumulation operation ends. In this way, the function of performing reset scan and readout scan at different times for each region of an image pickup device will be referred to as electronic rolling shutter. By controlling start timing of readout scan, it is possible to configure shutter speed.

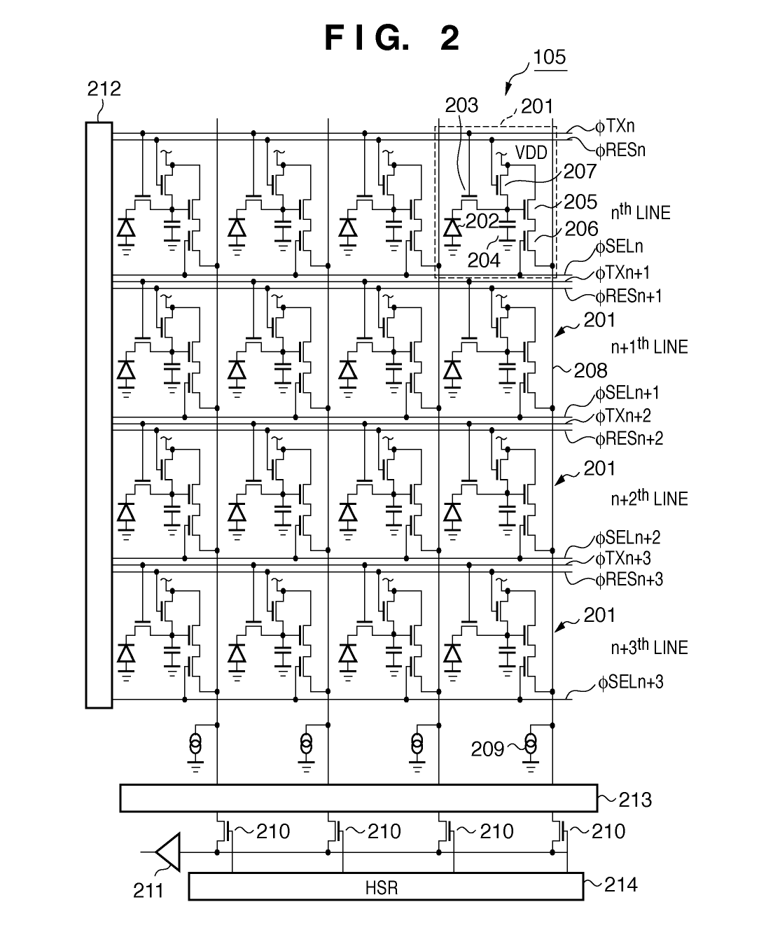

FIG. 2 shows an exemplary configuration of the image pickup device 105. A unit pixel 201 comprises a photodiode (PD) 202, a transfer switch 203, an electric charge detection unit (FD) 204, an amplification MOS amp 205, a selection switch 206 and a reset switch 207.

The PD 202 converts received light into electric charge. Transfer switch 203 transfers, to the FD 204 using a transfer pulse φTX, the electric charge generated at PD 202. The FD 204 temporarily accumulates the electric charge transferred from the PD 202. The amplification MOS amp 205 is an amplification MOS amp which functions as a source follower. The selection switch 206 selects pixel 201 using a selection pulse φSELV. The reset switch 207 removes electric charge accumulated at the FD 204 using a reset pulse φRES. The FD 204, the amplification MOS amp 205 and a constant current source 209, to be explained later, together comprises a floating diffusion amp.

A column of pixels 201 aligned in a vertical direction, and their respective selection switches 206, are connected to a signal output line 208. Electric charge, accumulated at the pixels 201 that are selected by the selection switches 206, is converted to electric voltage, and is outputted to a readout circuit 213 via the signal output line 208. To the signal output line 208, the constant current source 209, which acts as a load of the amplification MOS amp 205, is connected.

The selection switches 210 which select output signals from the readout circuit 213 are driven by a horizontal scanning circuit 214 based on the timing signals from the timing generation unit 107. Further, a vertical scanning circuit 212 outputs transfer pulses φTX, selection pulses φSELV and set pulses φRES based on the timing signals provided from the timing generation unit 107. With these, the vertical scanning circuit 212 selects switches 203, 206 and 207 at each of the pixels 201.

At each of the lines to which the pulses φTX, φRES and φSELV are supplied, the n^{th} scan line, which is scan-selected by the vertical scanning circuit 212, is referred to as scan line φTXn, scan line φRESn and scan line φSELVn.

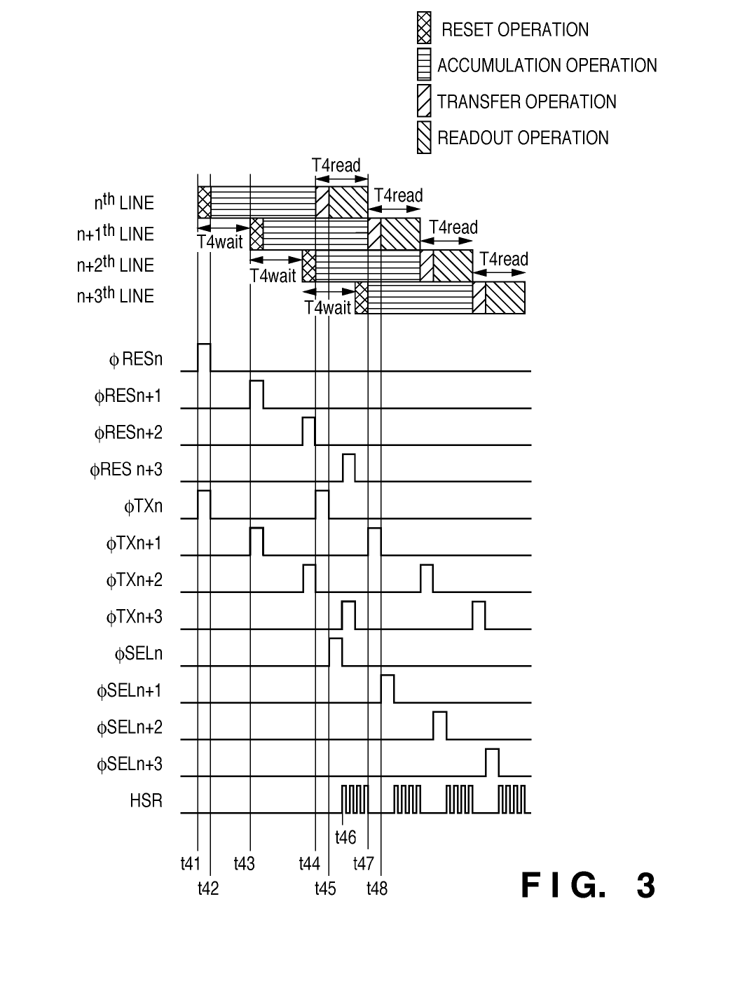

FIG. 3 shows an example of driving pulses and operational sequence during operation of an electronic rolling shutter. For the sake of simplicity, FIG. 3 only illustrates n^{th} line to n+3^{th} line which are scan-selected by the vertical scanning circuit 212.

At the n^{th} line, the reset pulse φRES and the transfer pulse φTX are respectively applied to the scan lines φRESn and φTXn between time t41 and time t42, then the transfer switch 203 and the reset switch 207 are turned on. By doing so, each of the pixels 201 of the n^{th} line will be reset, and the unnecessary electric charge accumulated at the PD 202 and the FD 204 will be removed.

After the reset operation is performed, the transfer switch 203 is turned off at time t42, and an accumulation operation of accumulating at the FD 204 the photo-electric charge generated at the PD 202 is initiated. Subsequently, at time t44, the transfer pulse φTX is applied to the scan line φTXn and the transfer switch 203 is turned on, then a transfer operation of transferring photo-electric charge accumulated at the PD 202 to the FD 204 is performed. From time t42 at which the transfer switch 203 is turned off, to time t44 at which the transfer switch 203 is turned on again, is the electric charge accumulation time for the FD 204.

The reset switch 207 needs to be turned off prior to this transfer operation and thus the transfer switch 203 and the reset switch 207 are simultaneously turned off at time t42 in the example given in FIG. 3.

After performing the transfer operation of the n^{th} line, the selection pulse φSELV is applied to the scan line φSELVn, and the selection switch 206 is turned on. By doing so, the electric charge accumulated at the FD 204 is converted to electric voltage, which is outputted to the readout circuit 213 via the signal output line 208. The readout circuit 213 temporarily retains the signal provided via the signal output line 208.

The signals which are temporarily retained at the readout circuit 213 are read out by controlling the selection switches 210 by the horizontal scanning circuit 214, and are sequentially outputted as signals for individual pixels at time t46.

The time between the onset of transfer at time t44 to the end of readout at time t47 will be referred to as readout interval T4read at the n^{th} line, and the time between time t41 and time t43 will be referred to as wait interval T4wait at the n+1^{th} line. Equally for other lines, the time between the start of transfer to the end of readout will be readout interval T4read, and the time between the start of the reset for the line and the start of reset for the subsequent line will be wait interval T4wait.

As discussed, in the operation of an electronic rolling shutter, the timing of electric charge accumulation differs depending on the position in the vertical direction of the image pickup device. To the contrary, the time required for accumulation of electric charge at each of the pixels can be made identical regardless of the position in the vertical direction of the image pickup device.

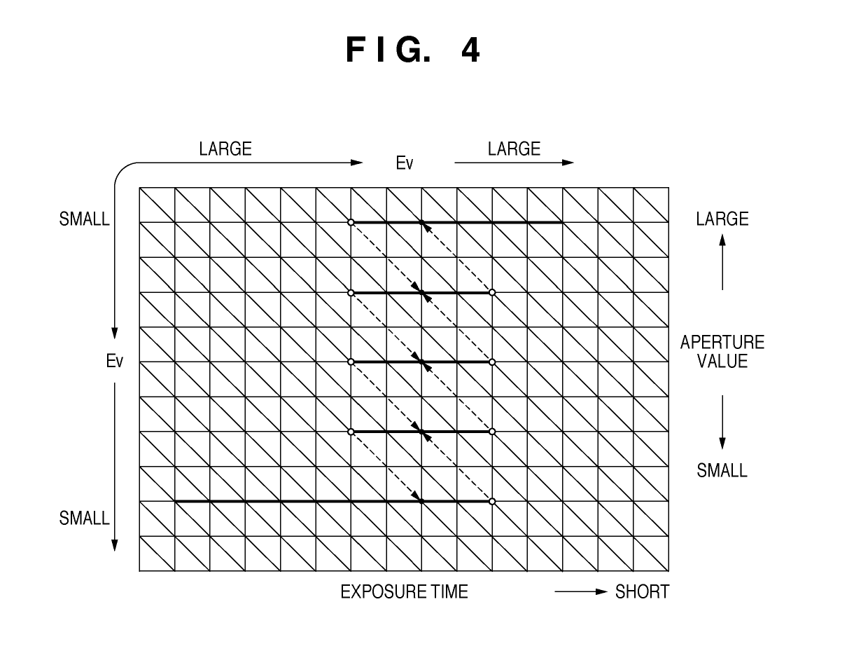

FIG. 4 shows an exemplary program diagram, which is applicable to the present invention, for live view and recording when picking up a moving image. In FIG. 4, the vertical axis represents aperture value, the horizontal axis shutter speed (exposure time), and the diagonal line luminance (EV value). The F number of aperture value decreases towards the bottom, and the shutter speed becomes faster towards the right side. Further, the EV value increases from the bottom left to the upper right.

As shown in FIG. 4, the first embodiment provides a limit to the number of steps of the aperture value, and the control of exposure taking place at identical aperture value is performed by the electric rolling shutter. The electric rolling shutter is capable of changing shutter speed for each frame as well as fine time control, allowing smooth exposure control. As shown in FIG. 4 by the arrows from hollow circles (∘) to solidly filled circles (), when the shutter speed reaches the pre-set upper or lower limit within an identical aperture value in response to the change in luminance, the aperture value is advanced to the next step, and the shutter speed is controlled such that the EV value (luminance) becomes equal.

### Regarding the Processing of the First Embodiment

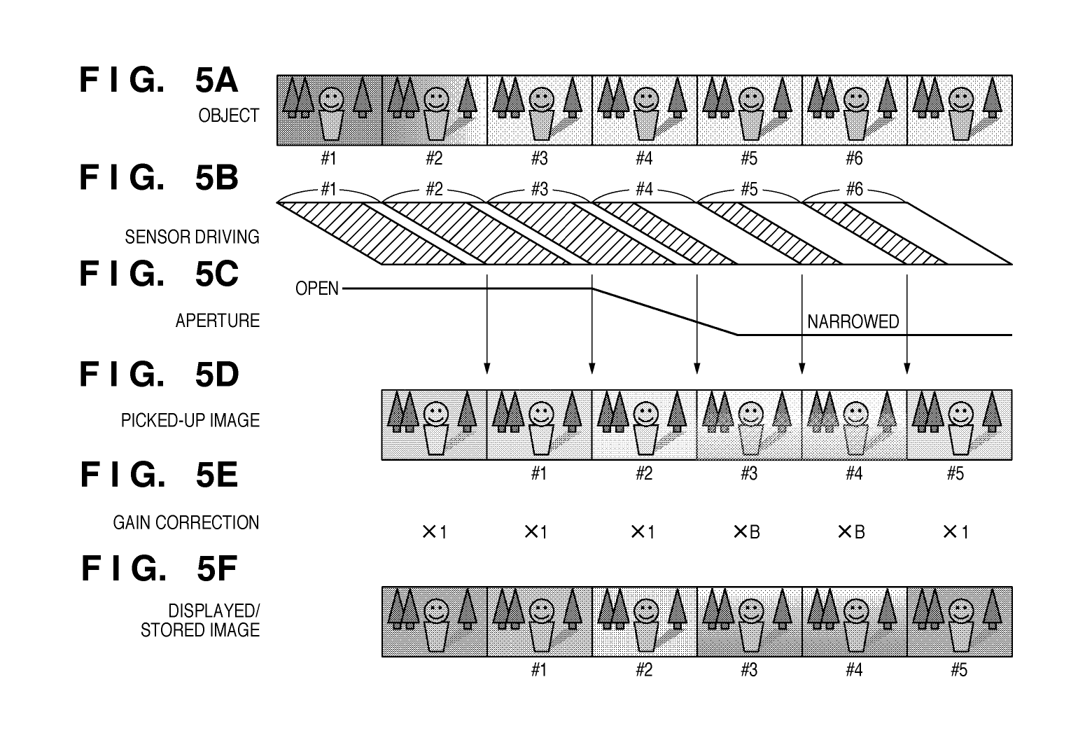

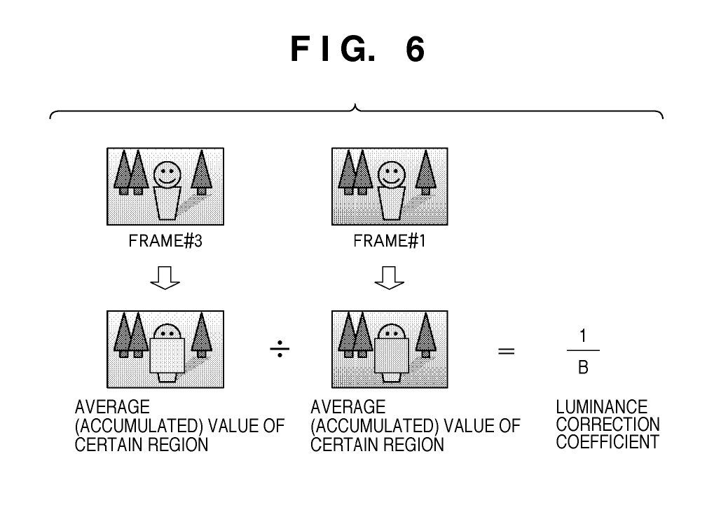

With reference to FIGS. 5A to 5F as well as FIG. 6, the processing according to the first embodiment of the present invention will be explained. In the first embodiment, the image signals of inappropriately exposed frames are corrected to reduce the difference between the luminance values of appropriately exposed frames according to the program diagram and the luminance values of inappropriately exposed frames which deviated from the program diagram. More specifically, a correction coefficient B is calculated from the ratio of luminance values within certain regions from the appropriately exposed frames and the inappropriately exposed frames. Using the correction coefficient B, gain correction is performed on the signal of the inappropriately exposed frame, obtaining an output image signal in which image quality deterioration due to inappropriate exposure is suppressed.

FIGS. 5A to 5F show an exemplary operation according to the first embodiment, wherein the aperture value has advanced to the next step in response to change in luminance of the object while picking up a moving image. In FIGS. 5A to 5F, time progresses towards the right and numbers #1 to #6 respectively indicate the corresponding frames. FIG. 5A shows luminance change of the object for each frame.

FIG. 5B shows an exemplary driving of the image pickup device 105 by the electronic rolling shutter, wherein the vertical direction indicates the order of lines of the image pickup device. Areas that are not shaded indicate time for electric charge accumulation in the order of lines. The time for accumulation for a single line corresponds to shutter speed. As explained using FIG. 3, the image pickup device 105 is driven, and time for 1 frame is required from the end of scanning the first line to the end of scanning the last line in this example.

FIG. 5C indicates aperture, wherein the upper side is an open state with a small aperture value. In other words, FIG. 5C shows a situation where the aperture is driven to the closure direction, and aperture value is advanced to a value which is larger by one step. FIG. 5D roughly shows image signals and exposure conditions of each of the frames obtained by exposure of the image pickup device. FIG. 5E shows the correction coefficient B calculated for each individual frame calculated according to the first embodiment. Further, FIG. 5F schematically shows image signals resulting from application of gain correction using the correction coefficient B to image signal of each frame shown in FIG. 5D. The image signals that are shown in FIG. 5F are eventually used for display and recording.

As exemplified in FIG. 5A, change in luminance occurs between frame #1 and frame #2, wherein the image of frame #2 has become brighter than the image of frame #1. For example, the image signal processing unit 106 compares luminance components of image signals for each frame in sequence, and detects changes in luminance between frames.

In this case, a sequence of control such as one described below is performed. This change in luminance is detected at the overall control and computing unit 109 based on the luminance components of image signals supplied to the image signal processing unit 106 from the image pickup device 105, for example. When a change in luminance of the subject is detected, the overall control and computing unit 109 determines whether the aperture value is to be advanced to the next step, based on the present shutter speed, aperture value and program diagram. If a decision is made to advance the aperture value, a control signal is output to the lens driving unit 102 to change the aperture value.

The lens driving unit 102 drives the optical aperture mechanism to bring the aperture value to a designated value, according to the control signal supplied. As a result, for example as shown in FIG. 5C, time equivalent to 1.5 frames is required from when the driving starts to when the predetermined aperture value is reached. In the present first embodiment driving of the aperture is performed by, for example, open control. As an example, the aperture driving time required from the start of aperture driving to reaching the predetermined aperture value can be obtained by referring to a table which correlates the first and second aperture values to the driving time of driving the aperture from the first aperture value to the second aperture value. A table correlating amounts of change in aperture and time required for aperture change (aperture driving duration), may be stored in the ROM of the overall control and computing unit 109. And, the overall control and computing unit 109 derives the aperture driving duration by referring to the above-mentioned table, and determines whether the aperture is being driven or not.

On the other hand, in regard to shutter speed, as shown in FIG. 5B, by the time readout of frame #2 is completed, readout of the subsequent frame #3 is initiated and is in progress. Therefore, the overall control and computing unit 109 controls the timing generation unit 107, and outputs timing signals to the image pickup device 105 such that the shutter speed reaches a predetermined value from the onset of frame #4. At the image pickup device 105, the shutter speed is immediately altered at frame #4 according to these timing signals.

As described above, as a result of controlling aperture value and shutter speed in response to change in luminance value, appropriate exposure cannot be performed for frames that include aperture driving duration in which the aperture value is changing, as shown in FIG. 5D, because the aperture value and shutter speed deviate from the line of the program diagram. In the example shown in FIG. 5D, overexposure occurs in frame #2 in which change in luminance took place, as well as in frames #3 and #4 in which aperture value is changing.

In such a situation, in the present first embodiment, as shown in FIG. 6, an average luminance value of a certain region is calculated from the frame that is appropriately exposed and that has aperture value and shutter speed which are in accordance with the program diagram. As an example of an appropriately exposed frame, frame #1, which comes immediately before frame #2 in which change in luminance is detected, can be utilized. In addition, an average luminance value of a certain region from the frame that is not appropriately exposed because of deviation of aperture value and shutter speed from the program diagram during aperture driving duration is also calculated. As an example of an inappropriately exposed frame, frame #3, which comes immediately after frame #2 in which change in luminance is detected, can be utilized. Then, from the ratio of the first average value calculated from the appropriately exposed frame to the second average value calculated from the inappropriately exposed frame, the correction coefficient B is calculated. In the example shown in FIG. 6, the inverse of the value obtained by dividing the second average value by the first average value is used as the correction coefficient B.

The region which is used for calculation of average luminance value, as shown in FIG. 6 for example, can be pre-set at the center of the image. Without restricting to this particular setup, a region can be set to correspond to that of the photometry mode currently set in the DSLR camera 100. In this case, it is possible to change the region depending on the photometry mode such as partial photometry, spot photometry, etc. Further, the entire image can also be used as the region.

The overall control and computing unit 109, for example, calculates the correction coefficient B based on the image signals supplied to the image signal processing unit 106 from the image pickup device 105. This correction coefficient B is handed over to the image signal processing unit 106. The image signal processing unit 106 then multiplies the correction coefficient B to the image signals as exemplified in FIG. 5E, supplied from the image pickup device 105, of the frames that include aperture driving duration (in this example frames #3 and #4). For image signals of other frames, a correction coefficient of 1 is used. It may also be arranged to have the correction coefficient B calculated directly by the image signal processing unit 106. As an example, the gain of amplification processing for image signals supplied from the image pickup device 105 is set based on this correction coefficient B and the luminance correction of frames taken during aperture driving duration are performed.

The image signal processing unit 106 performs A/D conversion and other (predetermined) image processing on the image signals to which the correction coefficient B is multiplied. The signals then are outputted by the image signal processing unit 106, which is displayed on the display unit 115 or stored in the storage medium 111. From this process, as shown in FIG. 5F, the images which are displayed on the display unit 115 and stored in the storage medium 111, with the exception of the image of frame #2, are images for which change in luminance is suppressed.

In the above, the correction using the correction coefficient B is performed at the image signal processing unit 106 by setting the gain for the image signals supplied from the image pickup device 105. However, the present invention is not limited to this particular example. For instance, the correction using the correction coefficient B can also be performed on images which are already A/D converted at the image signal processing unit 106. Further, it is also possible to have the overall control and computing unit 109 perform the correction to output image data stored in the memory 108.

Additionally, although the correction coefficient B is calculated using average luminance values from certain regions of concerned frames in the above description, the present invention is not limited to this example. For instance, the correction coefficient B can also be calculated using an accumulated luminance value of the region of the pertinent frames.

### Second Embodiment

Next, a second embodiment of the present invention will be explained. Accurate timing for the aperture driving duration can easily be determined in a image pickup apparatus such as a compact digital camera in which the camera body and the lens are integrated into a single unit and are controlled by a common system. On the other hand, in DSLR cameras having interchangeable lenses in which the lens is separated from the camera body and controlled through communication between the camera body and the lens, it is difficult to determine accurate timing for aperture driving duration.

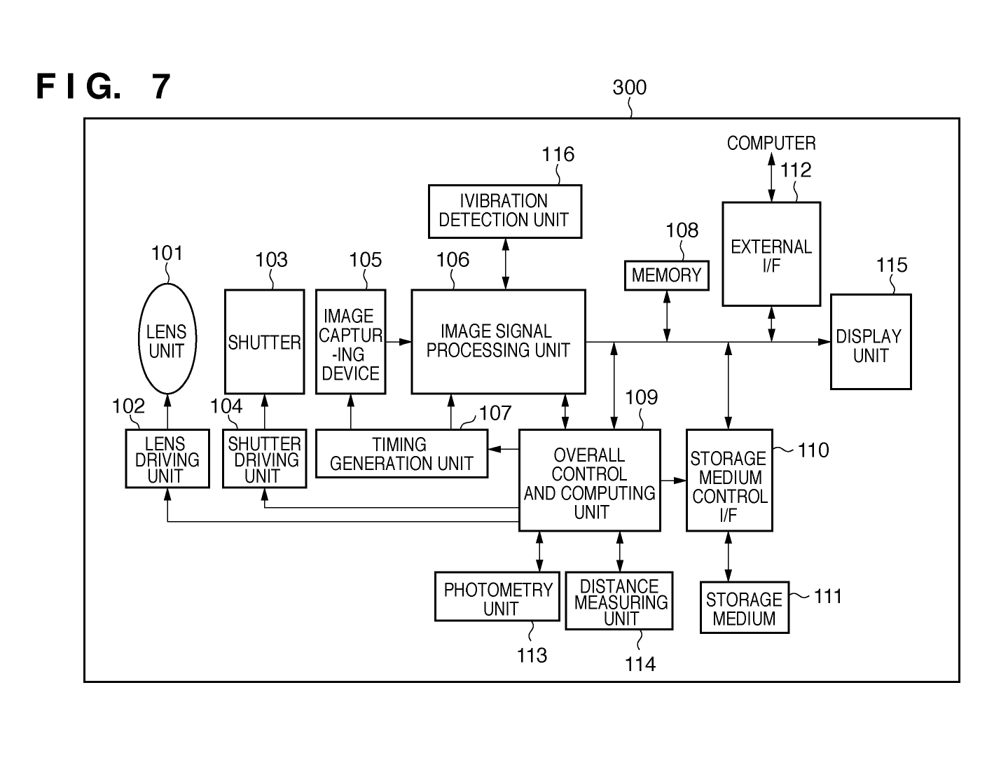

FIG. 7 shows an exemplary configuration of a DSLR camera 300 according to the second embodiment of the present invention. The DSLR camera 300 according to the present second embodiment, in comparison to the DSLR camera 100 of the first embodiment shown in FIG. 1, has an added vibration detection unit 116 which acts as driving detection means and vibration detection means. Since other parts of the DSLR camera 300 have identical configuration to that of the DSLR camera 100 of FIG. 1, the common parts are assigned the identical reference numerals and detailed explanation therefor is omitted. Also, the configuration and driving method of the image pickup device 105, and program diagram are as discussed above in the first embodiment, and their explanation will thus be omitted.

The DSLR camera 300 is of type with interchangeable lens system, wherein the lens unit 101 and the lens driving unit 102 are built in on the side of the interchangeable lens side. Also, communication between the overall control and computing unit 109 and the lens driving unit 102 is to be performed via electrical contact at a lens mounting unit. The position at which the vibration detection unit 116 is placed is not restricted as long as it is within the body of the DSLR camera 300, but it is possible to place the unit at a position which is convenient for detecting vibration generated from the lens unit 101, such as a position in close proximity to the lens mount.

The vibration detection unit 116, for example, utilizes a piezoelectric element as a vibration sensor, and supplies output to the image signal processing unit 106 or the overall control and computing unit 109. The image signal processing unit 106 or the overall control and computing unit 109 detects aperture driving duration based on the supplied vibration sensor output.

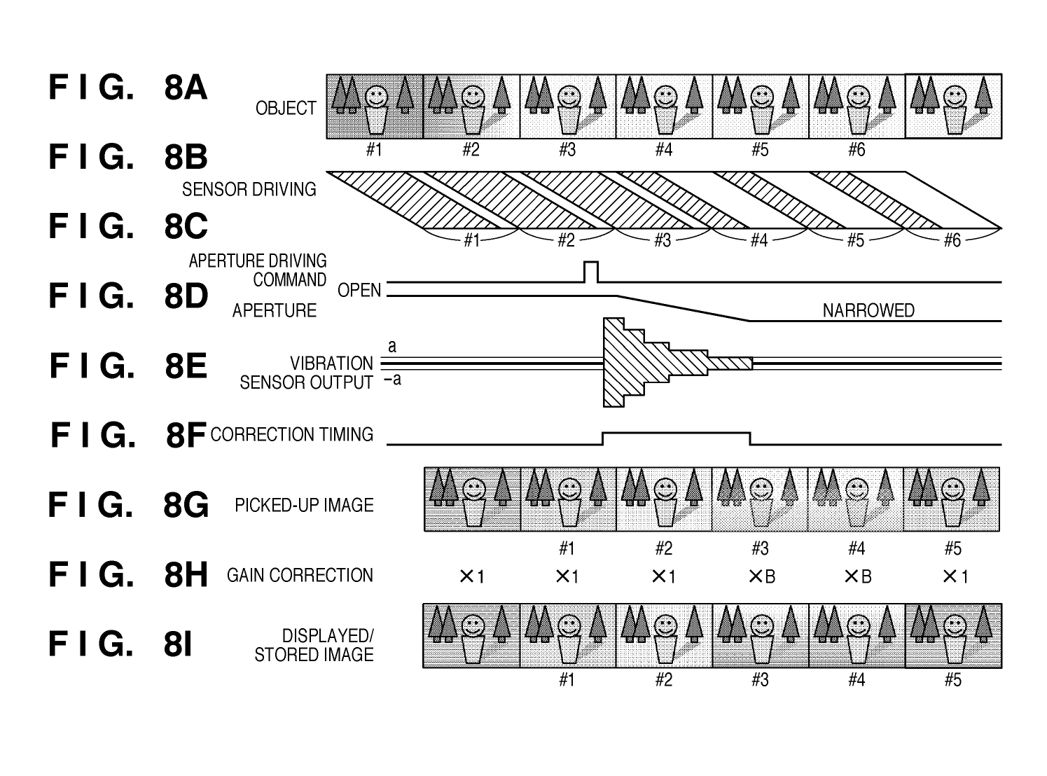

FIGS. 8A to 8I show an exemplary operation according to the present second embodiment, wherein the aperture value has advanced to the next step in response to change in luminance of the object while picking up a moving image. In FIGS. 8A to 8I, time progresses towards the right, and numbers #1 to #6 respectively indicate the corresponding frames. FIGS. 8A, 8B, 8D, and 8G respectively correspond to above-mentioned FIGS. 5A, 5B, 5C, and 5D.

FIG. 8A shows luminance change of the object for each frame. FIG. 8B shows an exemplary driving of the image pickup device 105 by the electronic rolling shutter. FIG. 8D indicates aperture. In the examples shown in FIGS. 8A to 8I, aperture driving is initiated according to the aperture driving command (FIG. 8C) generated by the overall control and computing unit 109 based on the result of photometry. For example, as shown in FIG. 8C, when initiating aperture driving based on photometry result from certain regions within frame, it is possible to issue aperture driving commands at time points at which all signals within the frame is not completely collected.

FIG. 8E shows an example of the vibration sensor output by the vibration detection unit 116. When aperture driving is initiated by the aperture driving command, vibrations generated from the driving of the aperture is detected by the vibration sensor. For example, when an aperture driving command is issued, detection of vibration is performed within a certain time frame. As an example, if the aperture driving duration is already known to be about 50 msec, vibration detection is performed for a time frame of 100 msec.

The output of the vibration sensor is compared to a given value ±a at a comparison device (not shown). If a driving command is issued from the overall control and computing unit 109, based on the comparison of the vibration sensor with the given value ±a, the time period during which the amplitude of the output signal from the vibration detection unit 116 is larger than the given value ±a is determined as the aperture driving duration. FIG. 8F show an example of the correction timing which is obtained on the basis of the output from the vibration sensor. In the frames of image signals outputted from the image pickup device 105 the frames including this correction timing (in this example, frames #3 and #4) are subjected to correction using the correction coefficient B.

The method of calculating and applying the correction coefficient are identical to those of the first embodiment, and the explanation thereof will be omitted.

As explained above, according to the present second embodiment, it is possible to directly know the aperture driving duration by detecting vibration of the aperture driving. Accordingly, it is possible to provide a system which does not require aperture control that is synchronized with frame timing.

In the present second embodiment, vibration that is generated during the driving of the aperture is detected using the vibration detection unit 116. However the present invention is not limited to this, and can use other methods to detect aperture driving duration. For example, detection of aperture driving duration can be performed by detecting noise generated during aperture driving.

### Third Embodiment

Next, a third embodiment of the present invention will be explained. In the above-described first embodiment, the correction coefficient B, which is used for correction of inappropriately exposed frames during aperture driving duration, was calculated using average luminance value or accumulated value in certain regions of the frames in concern. In contrast to this, the correction coefficient in the present third embodiment is obtained based on information indicating differences in luminance in vertical directions of images by image signals outputted by the image pickup device 105. The present embodiment calculates the correction coefficient based on projection in horizontal direction of images by image signals outputted by the image pickup device 105.

In the present third embodiment, the configurations of the DSLR camera 100 and the image pickup device 105, the driving method of the image pickup device 105 and the program diagram can be identical to the above-described first embodiment, and thus the explanation thereof will be omitted.

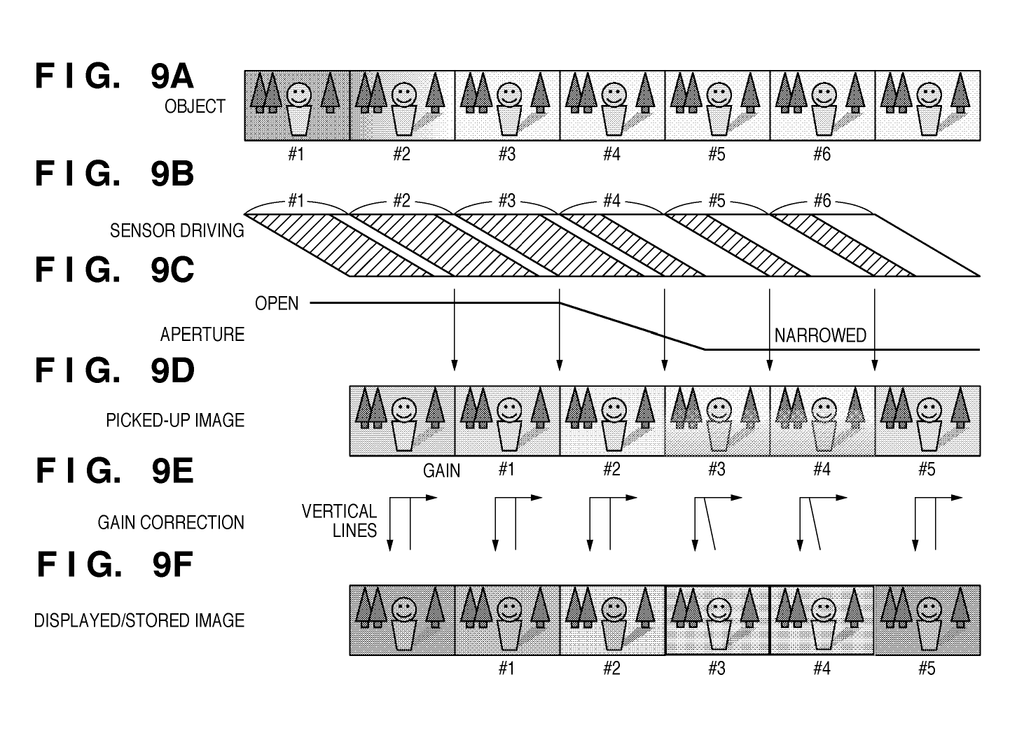

FIGS. 9A to 9F show an exemplary operation according to the present third embodiment, wherein the aperture value has advanced to the next step in response to change in luminance of the object while picking up a moving image. In FIGS. 9A to 9F, FIGS. 9A to 9D and FIG. 9F are identical to FIGS. 5A to 5D and FIG. 5F, and their explanation will be omitted.

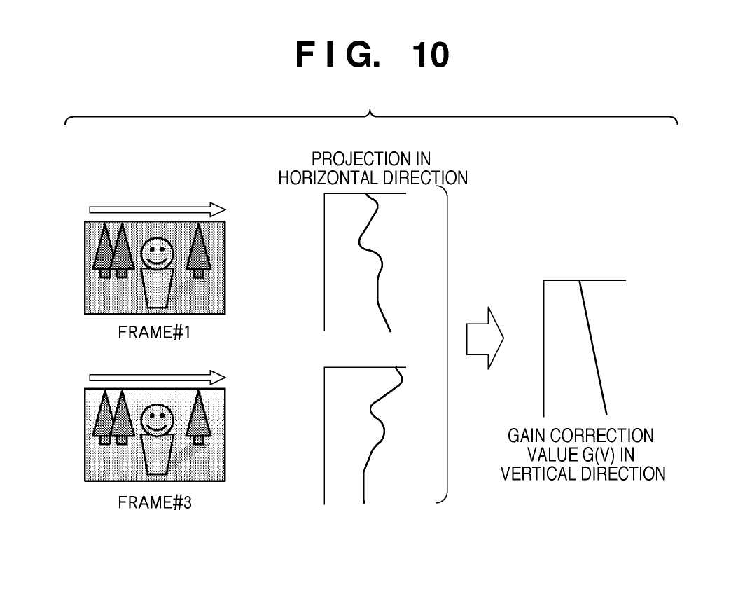

With reference to FIG. 10, an exemplary method of calculating a gain correction value G(v) in vertical direction based on horizontal projection of images will be explained. If a change in luminance occurs at frame #2, then projections in horizontal directions are calculated from each of the image signals of the appropriately exposed frame #1 and inappropriately exposed frame #3 (FIG. 10, left and middle). Then the ratio of the horizontal projection of the image signal of frame #1 and the horizontal projection of the image signal of frame #3 is obtained and the vertical gain correction value G(v) is calculated (FIG. 10, right). In other words, the vertical gain correction value G(v) is a correction coefficient for each individual lines of image signals.

The image signal processing unit 106, for example, accumulates luminance values of each individual pixel in each line of image signals supplied from the image pickup device 105, thereby calculating the horizontal projection of the image signal. Then, when a luminance change is detected and aperture driving is started, the ratio of the horizontal projections obtained from image signals during and prior to the aperture driving is calculated. Then, a vertical gain correction value G(v) is calculated based on this ratio (FIG. 9E). This vertical gain correction value G(v) is multiplied to image signals which include aperture driving duration (frames #3 and #4 in this example). In this case, corresponding vertical gain correction values G(v) are multiplied to each pixel in the corresponding lines of the image signals of the relevant frames.

The image signal processing unit 106 performs A/D conversion and other certain image processing to the image signals to which the vertical gain correction values G(v) are multiplied, and outputs them to be displayed on the display unit 115 or stored in the storage medium 111. By doing so, as shown in FIG. 9F, the images displayed on the display unit 115 or stored in the storage medium 111, with the exception of frame #2 in which change in luminance occurred, are images for which change in luminance is suppressed.

In the present third embodiment, gain correction is performed on image signals of frames during the aperture driving duration based on horizontal projections. From this, it becomes possible to suppress exposure deviation of frames during aperture driving duration, and also has an effect of correcting unevenness in exposure, leading to higher quality of moving images.

In the above, occurrence of overexposure during aperture driving duration is explained. However, it is obvious that each of the embodiments of the present invention can be applied in the same way in situations where underexposure occurs during aperture driving duration.

Further, although a CMOS image sensor is utilized as the image pickup device 105 in the above, each of the embodiments of the present invention is just as effective even when the image pickup device 105 is a CCD sensor.

Furthermore, in each of the above mentioned embodiments, the correction coefficient B or the vertical gain correction value G(v), is calculated based on frames immediately before and after the frame in which a change in luminance is detected. And correction is performed by uniformly applying the calculated correction coefficient B or vertical gain correction value G(v) to the frames included in the aperture driving duration. The present invention is not limited to this, and can also perform correction for each frame by, for example, calculating the correction coefficients B or vertical gain correction values G(v) for each frame included in the aperture driving duration in sequence.

### Other Embodiment

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment (s). For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2008-237185, filed on Sep. 16, 2008, which is hereby incorporated by reference herein in its entirety.

What is claimed is:

1. An image pickup apparatus comprising:
an image pickup unit that generates an image signal by photoelectric conversion of light flux incoming via an aperture;
a detection unit that detects luminance of an image signal generated by the image pickup unit;
a computing unit that computes an aperture value of the aperture based on the detection result of the detection unit;
an exposure control unit that performs exposure control by adjusting the aperture to the aperture value computed by the computing unit; and
a correction unit that performs correction of luminance on an image signal generated by photoelectric conversion of the light flux incoming to the image pickup unit when performing adjustment of the aperture in response to change in luminance of an object, based on luminance of an image signal generated prior to performing said adjustment of the aperture.

2. The image pickup apparatus of claim 1, wherein
the correction unit performs the correction using:
luminance of a certain region of an image which is based on an image signal generated by photoelectric conversion of the light flux incoming to the image pickup unit when performing adjustment of the aperture; and
luminance of a certain region of an image which is based on an image signal generated prior to performing said adjustment of the aperture.

3. The image pickup apparatus of claim 1, wherein
the correction unit performs the correction using:
information indicating a difference between luminance in a vertical direction of an image based on an image signal generated by photoelectric conversion of the light flux incoming to the image pickup unit when performing adjustment of the aperture; and
information indicating a difference in luminance in a vertical direction of an image based on an image signal generated prior to performing said adjustment of the aperture.

4. The image pickup apparatus of claim 1, further comprising:
a storage unit that stores a table correlating amount of change in aperture when performing adjustment of the aperture with time required for the corresponding change in aperture; and
a determination unit that determines whether or not adjustment of the aperture is being performed by referring to the table.

5. The image pickup apparatus of claim 1, further comprising:
a drive detection unit that detects driving of the aperture; and
a determination unit determines whether or not adjustment of the aperture is being performed by referring to the detection result of the drive detection unit.

6. The image pickup apparatus of claim 5, wherein
the drive detection unit detects the driving of the aperture by detecting vibration that is generated from driving the aperture.

7. A method of controlling an image pickup apparatus having an image pickup unit that generates an image signal by photoelectric conversion of light flux incoming via an aperture, the method comprising:
a detection step of detecting luminance of an image signal generated by the image pickup unit;
a computing step of computing an aperture value of the aperture based on the detection result from the detection step;
an exposure control step of performing exposure control by adjusting the aperture to the aperture value computed at the computing step; and
a correction step of performing correction of luminance on an image signal generated by photoelectric conversion of the light flux incoming to the image pickup unit when performing adjustment of the aperture in response to change in luminance of an object, based on luminance of an image signal generated prior to performing said adjustment of the aperture.
